(19) United States
(12) Patent Application Publication
(10) Pub. No.: US 2025/0224664 A1
(43) Pub. Date: Jul. 10, 2025

(54) DEVICE FOR OPTIMIZING SOURCE MASK AND LITHOGRAPHY SYSTEM INCLUDING THE SAME

(71) Applicant: Samsung Electronics Co., Ltd., Suwon-si (KR)

(72) Inventors: Sungmin NAM, Suwon-si (KR); Hyunseok NOH, Suwon-si (KR); SEUNGHUNE YANG, Suwon-si (KR); Seongjeon CHOI, Suwon-si (KR)

(21) Appl. No.: 18/775,195

(22) Filed: Jul. 17, 2024

(30) Foreign Application Priority Data
Jan. 10, 2024 (KR) 10-2024-0003955

(51) Int. Cl. G03F 1/36; G06F 30/398; G06F 119/18

(52) U.S. Cl. CPC G03F 1/36; G06F 30/398; G06F 2119/18

(57) ABSTRACT

A device for optimizing a source mask generates an illumination system and a mask output set based on an input mask image and a user input. The user input includes target constraints. The device for optimizing the source mask generates a plurality of split mask images based on an input mask image, generates a plurality of source mask sets corresponding to the plurality of split mask images, by performing a dual point source simulation for each of the split mask images, based on a plurality of dual point source sets, and generates a plurality of dose optimized source mask sets by performing dose optimization with respect to each of the plurality of source mask sets, based on a target value for a degree of light exposure of a resist pattern, wherein each of the plurality of dual point source sets includes two point sources having telecentric symmetry with respect to each other.

### CROSS-REFERENCE TO RELATED APPLICATIONS

This application claims priority under 35 U.S.C. § 119 to Korean Patent Application No. 10-2024-0003955 filed on Jan. 10, 2024, in the Korean Intellectual Property Office, the disclosure of which is incorporated by reference herein in its entirety.

### BACKGROUND

Embodiments of the present disclosure described herein relate to a device for optimizing a source mask, and more particularly, relate to a device for outputting a photomask pattern used in a lithography process and an illumination system optimized for the photomask pattern.

In the semiconductor industry, extreme ultraviolet (EUV) patterning is studied as a next-generation photolithography technology. In addition, the development of photoresists to support the EUV patterning is in progress. As part of the development of the EUV patterning process, simulations may be performed under an environment in which the EUV patterning process is performed, such that constraints for the lithography process are satisfied. For example, a simulation (hereinafter, a source mask optimization simulation) for optimizing a source mask may be performed to select an illumination system and a photomask optimized to satisfy process constraints under the environment in which the EUV patterning process is performed.

The simulation for optimizing the source mask may be to optimize an illumination system for satisfying the condition of the process constraints by setting a pupil facet mirror of an EUV lithography device as the illumination system and to optimize a photomask for satisfying the condition of the process constraints under the situation where the optimized illumination system is used.

In this case, the optimization for the photomask is performed after the optimization for the illumination system is performed. Accordingly, when the settings for a mask pattern shape are changed, the optimization for the illumination system has to be performed again depending on the condition of the process constraints and the optimization for a mask image has to be performed again depending on the optimized illumination system.

For example, when the pattern size of the mask image is changed depending on dose constraints after the simulation for optimizing the source mask is performed, the simulation for selecting the optimized illumination system has to be performed again, and the mask image has to be optimized again depending on the optimized illumination system.

### SUMMARY

Embodiments of the present disclosure provide a device for optimizing a source mask, capable of simultaneously outputting an optimized illumination system and an optimized mask which satisfy constraints.

Embodiments of the present disclosure provide a device for optimizing a source mask, capable of performing dose optimization.

According to an embodiment, a non-transitory computer-readable medium includes a program code configured, when executed by a processor, to perform the following: generating a plurality of split mask images based on an input mask image; generating a plurality of source mask sets corresponding to the plurality of split mask images, by performing a dual point source simulation for each of the plurality of split mask images, based on a plurality of dual point source sets; generating a plurality of dose optimized source mask sets by performing dose optimization with respect to each of the plurality of source mask sets, based on a target value for a degree of light exposure of a resist pattern to be formed based on an output mask image, each of the plurality of dose optimized source mask sets including a dose optimized split mask image and a dose optimized point source set; selecting an optimal source mask set from among the plurality of dose optimized source mask sets, the optimal source mask set including an optimal split mask image and an optimal point source set; determining whether the optimal source mask set satisfies input target constraints; and outputting, based on the determination result, the optimal point source set and the optimal split mask image, and wherein each of the plurality of dual point source sets includes two point sources having telecentric symmetry with respect to each other.

According to an embodiment, a method includes, using a source mask optimization simulation tool: generating a plurality of split mask images based on an input mask image; generating a plurality of source mask sets corresponding to the plurality of split mask images, by performing a dual point source simulation for each of the plurality of split mask images, based on a plurality of dual point source sets; generating a plurality of dose optimized source mask sets by performing dose optimization with respect to each of the plurality of source mask sets, based on a target value for a degree of light exposure of a resist pattern to be formed based on an output mask image, each of the plurality of dose optimized source mask sets including a dose optimized split mask image and a dose optimized point source set; selecting an optimal source mask set from among the plurality of dose optimized source mask sets, the optimal source mask set including an optimal split mask image and an optimal point source set; determining whether the optimal source mask set satisfies input target constraints; and outputting the optimal source mask set based on the determination result; fabricating a photomask, based on an optimal split mask image of the optimal source mask set; and forming the resist pattern on a wafer by performing a lithography process based on an optimal point source set of the optimal source mask set, and the photomask, wherein each of the plurality of dual point source sets includes two point sources having a telecentric symmetry with respect to each other.

According to an embodiment, a non-transitory computer program stored in a storage medium is configured to perform, by using a computer, a method including: generating a plurality of split mask images based on an input mask image; generating a plurality of source mask sets corresponding to the plurality of split mask images, by performing a dual point source simulation for each of the plurality of split mask images, based on a plurality of dual point source sets; selecting an optimal source mask set from among the plurality of source mask sets, the optimal source mask set including an optimal split mask image and an optimal point source set; determining whether the optimal source mask set satisfies input target constraints; and outputting the optimal source mask set based on the determination result, wherein each of the plurality of dual point source sets includes two point sources having a telecentric symmetry with respect to each other.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a device for optimizing a source mask according to an embodiment of the present disclosure.

FIG. 2 is a flowchart illustrating an operating manner of a tool for a source mask optimization simulation in a device for optimizing the source mask of FIG. 1.

FIG. 3 is a view illustrating a mask input image by way of example.

FIG. 4 is a view to describe step S120 of FIG. 2.

FIG. 5 is a flowchart to describe step S130 of FIG. 2.

FIG. 6 is a view illustrating a pupil facet mirror illumination system by way of example.

FIG. 7 is a view to describe step S131 of FIG. 5.

FIG. 8 is a view to describe step S132 of FIG. 5.

FIG. 9 is a view to describe step S140 of FIG. 2.

FIG. 10 is a block diagram illustrating a device for optimizing a source mask according to an embodiment of the present disclosure.

FIG. 11 is a flowchart illustrating operations of a dose optimization unit and a selecting unit of FIG. 10.

FIG. 12 is a view to describe step S135 of FIG. 11.

FIG. 13 is a view to describe step S145 of FIG. 11.

FIG. 14 is a view illustrating results of a source mask optimization simulation according to comparative examples and embodiments of the present disclosure.

FIG. 15 is a view illustrating an implementation of a device for optimizing a source mask according to the present disclosure.

FIG. 16 is a view illustrating a lithography system according to an embodiment of the present disclosure.

FIG. 17 is a flowchart illustrating an operation of the lithography system of FIG. 16.

FIG. 18 is a view illustrating the lithography device of FIG. 15.

FIG. 19 is a view illustrating a field facet mirror and a pupil facet mirror of FIG. 18.

### DETAILED DESCRIPTION

Hereinafter, embodiments of the present disclosure will be described clearly and in detail, to the extent that those of ordinary skill in the art may easily reproduce the present disclosure.

Components and functional blocks illustrated in drawings using the terms “part”, “unit”, or “module” used in the detailed description may be implemented in the form of software, hardware, or the combination thereof. For example, software may be a machine code, firmware, an embedded code, and application software. For example, hardware may include an electric circuit, an electronic circuit, a processor, a computer, an integrated circuit, integrated circuit cores, a pressure sensor, an inertia sensor, a microelectromechanical system (MEMS), a passive element, or any combination thereof.

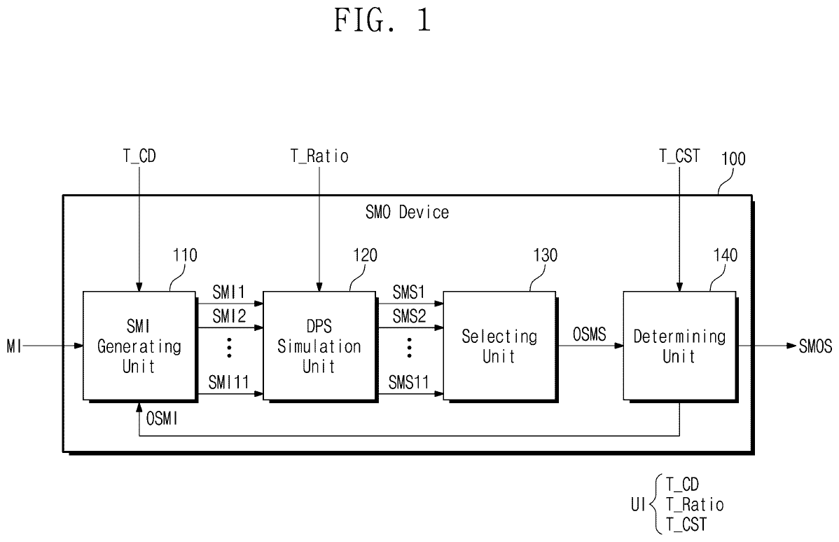

FIG. 1 is a block diagram illustrating a device (hereinafter, a source mask optimization device) for optimizing a source mask according to an embodiment of the present disclosure. A source mask optimization device 100 may be a device configured to perform a simulation (hereinafter, a source mask optimization (SMO) simulation) for optimizing a source mask. For example, the source mask optimization device 100 may be hardware which executes software serving as a source mask optimization simulation tool.

Referring to FIG. 1, the source mask optimization device 100 may be configured to generate an illumination system and a mask output set (SMOS) by performing the source mask optimization simulation based on an input mask image MI and a user input UI. The illumination system and the mask output set (SMOS) may include an output point source set generated as the result of the source mask optimization simulation, and an output mask image corresponding to the output point source set. The output point source set may include information on point sources turned on among a plurality of point sources constituting the illumination system of a Pupil Facet Mirror (PFM).

The input mask image MI may include a pattern image for fabricating a photomask. For example, the pattern image may be an image corresponding to a resist pattern to be produced on a wafer through a lithography process. For example, the pattern image of the input mask image MI may include a plurality of unit shapes (e.g., first unit shapes) repeatedly arrayed. In the pattern image, the plurality of unit shapes may have various array forms such as a one dimensional (1D) array, a two dimensional (2D) array, a staggered array, and a square array.

The user input UI may include various target information considered when forming the resist pattern in the lithography process. For example, the user input UI may further include information on a target critical dimension T_CD, which is a target value for a critical dimension of a pattern, a target aspect ratio T_Ratio, which is a target aspect ratio of a unit shape, and target constraints T_CST based on other process windows.

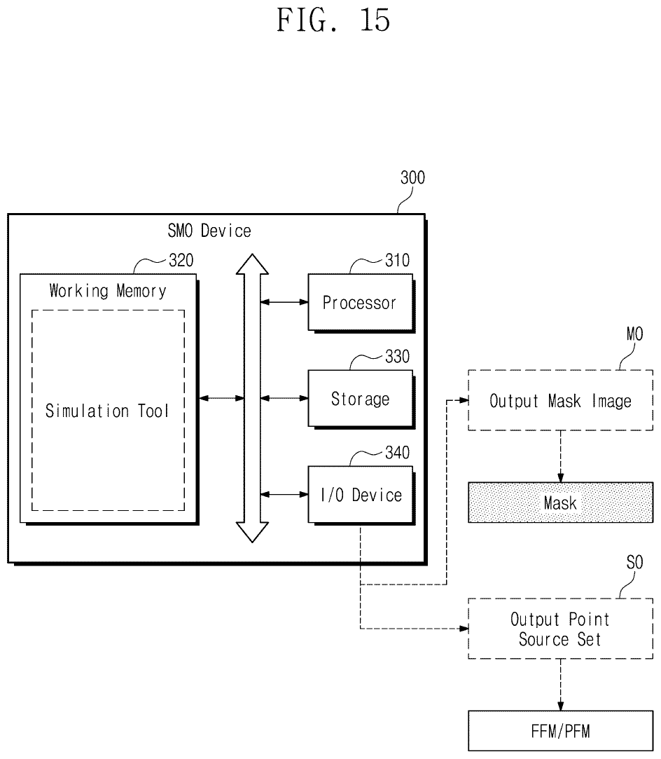

The source mask optimization device 100 may include a split mask image (SMI) generating unit 110, a dual point source (DPS) simulation unit 120, a selecting unit 130, and a determining unit 140. According to the present specification, ‘units’, which perform operations of the source mask optimization simulation performed in the source mask optimization device 100, will be separately described, but the present disclosure is not limited thereto. For example, the operations of the source mask optimization simulation may be achieved in a single hardware device. For example, as described later with reference to FIG. 15, the source mask optimization device 100 may be implemented in the form of a processor configured to perform the source mask optimization simulation, based on an instruction stored in the memory.

The SMI generating unit 110 may be configured to generate a plurality of split mask images, based on the input mask image MI. For example, the plurality of split mask images may include first to eleventh split mask images SMI1 to SMI11 formed by splitting the input mask image MI.

In the present specification, splitting of a mask image refers to generating a plurality of split mask images which are the same as each other in array form but different from each other in a unit shape. In other words, the split mask images different from each other may include unit shapes (e.g., second unit shapes) mutually different in shape or size.

The SMI generating unit 110 may generate a plurality of split mask images having mutually different lengths in a major axis and a minor axis of a unit shape based on a reference value. The unit shapes of the plurality of split mask images may have different aspect ratios.

According to an embodiment, the SMI generating unit 110 may set a reference value for each of the length of the major axis and the length of the minor axis of the unit shape of the input mask image MI, based on the target critical dimension T_CD.

According to another embodiment, the SMI generating unit 110 may set the reference value for each of the length of the major axis and the length of the minor axis of the unit shape to a preset value inside the device.

The plurality of split mask images may be the same as each other in the array form of the unit shapes. For example, the array forms of the plurality of split mask images may be the same as the array form of the input mask image MI. For example, an array form of a plurality of unit shapes of the first split mask image SMI1 may be the same as an array form of a plurality of unit shapes of the second split mask image SMI2. For example, the plurality of split mask images may each include a plurality of unit shapes arranged in an array form including straight rows and columns. The array form may be one-dimensional, two-dimensional, a square array or a staggered array, for example.

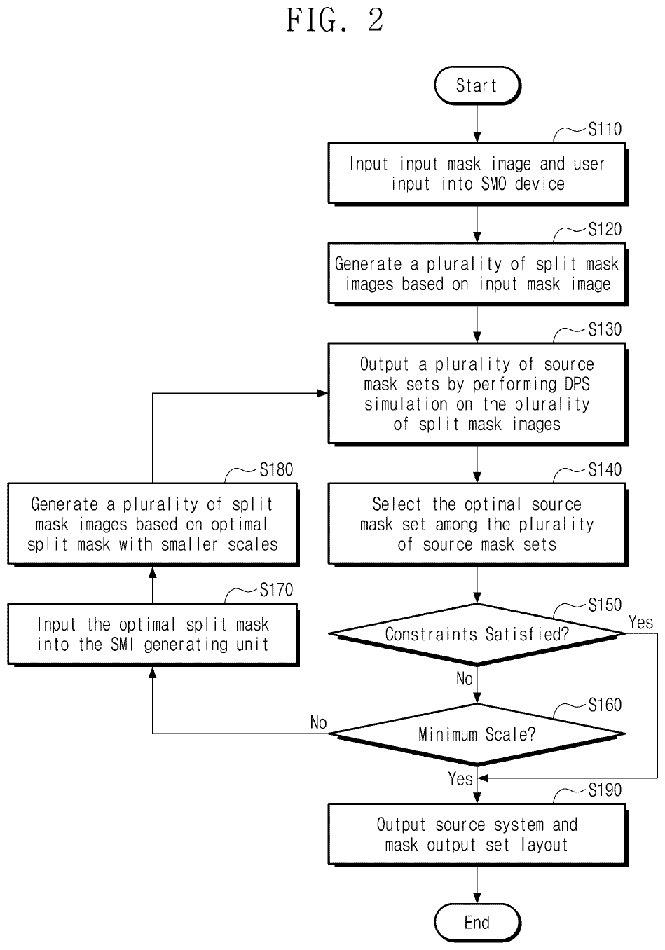

The detailed operation of the SMI generating unit 110 will be described later with reference to FIGS. 2 to 4.

The DPS simulation unit 120 may be configured to generate a plurality of source mask sets, by performing a dual point source (DPS) simulation based on a plurality of dual point source sets, with respect to the plurality of split mask images.

According to the present specification, a dual point source set may refer to two point sources, which have telecentric symmetry among the plurality of point sources constituting the illumination system of a PFM. In other words, the two point sources constituting the dual point source set may be disposed at a point-symmetric position about a center point of the PFM.

Each of a plurality of source mask sets may include a split mask image and point source sets corresponding to the split mask image. For example, the plurality of source mask sets may include first to eleventh source mask sets SMS1 to SMS11 corresponding to the first to eleventh split mask images SMI1 to SMI11. Each point source set may include a plurality of dual point source sets.

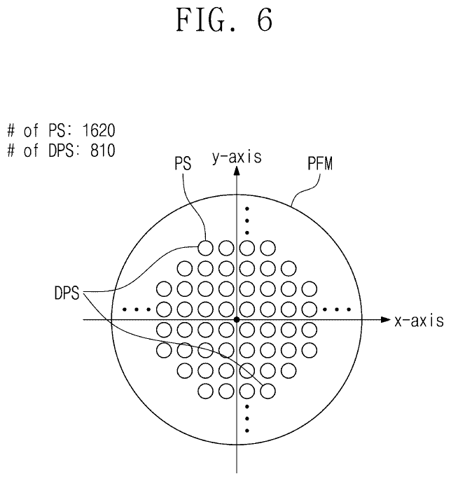

Details of performing the dual point source simulation in the DPS simulation unit 120 will be described later with reference to FIGS. 2 and 6.

The selecting unit 130 may select an optimal source mask set OSMS from the plurality of source mask sets. According to an embodiment, the selecting unit 130 may be configured to select the optimal source mask set OSMS based on a normalized image log-slope (NILS) value of the plurality of source mask sets.

The determining unit 140 may be configured to determine whether the optimal source mask set OSMS satisfies the target constraints T_CST. For example, the target constraints T_CST may include dose constraints associated with a degree of light exposure in the lithography process, critical dimension constraints associated with the critical dimension of a pattern, or NILS constraints associated with the NILS value.

Based on the determination result that the optimal source mask set OSMS fails to satisfy the target constraints T_CST, the determining unit 140 may provide an optimal split mask image OSMI included in the optimal source mask set OSMS as the input of the SMI generating unit 110.

The SMI generating unit 110 may be configured to re-generate a plurality of split mask images, based on the optimal split mask image OSMI received from the determining unit 140. As described above, the operations of the DPS simulation unit 120, the selecting unit 130, and the determining unit 140 may be subsequently performed again using the re-generated plurality of split mask images.

According to an embodiment, when a split mask image, which is selected, received from the determining unit 140 is split, the SMI generating unit 110 may be configured to split the selected split mask image such that the length of a major axis and the length of a minor axis in a unit shape are set into smaller intervals by setting a scale to be smaller than a scale used previously in the generating of the split mask images.

Based on the determination result that the optimal source mask set OSMS satisfies the target constraints T_CST, the determining unit 140 may be configured to output the optimal source mask set OSMS to the form of an illumination system and a mask output set SMOS.

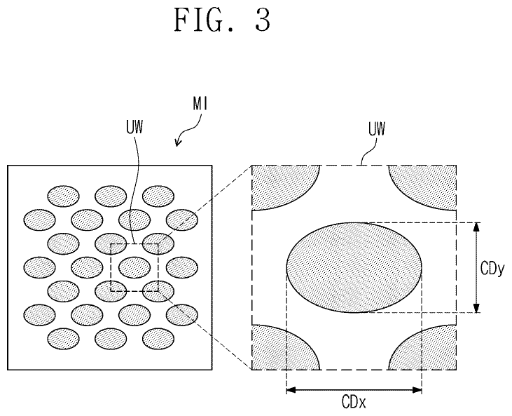

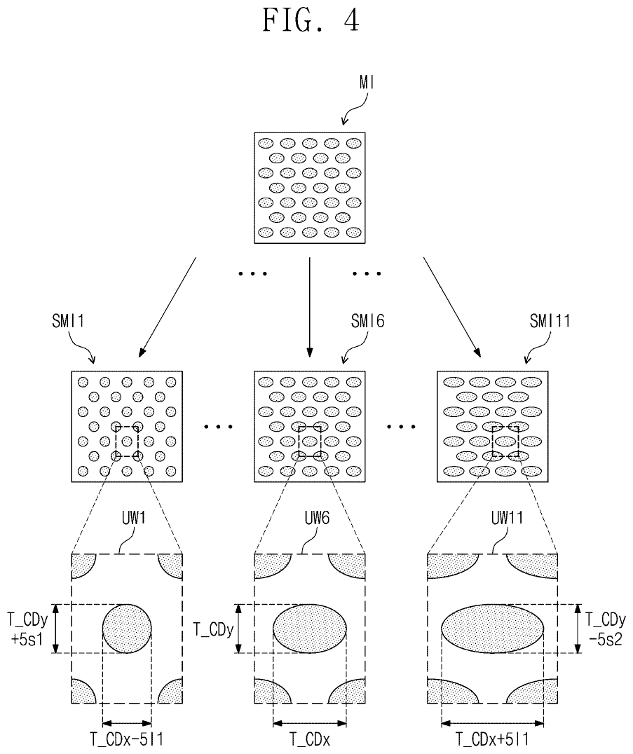

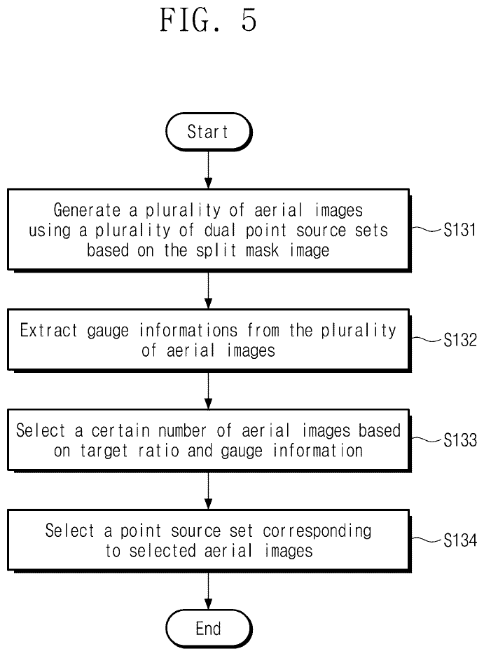

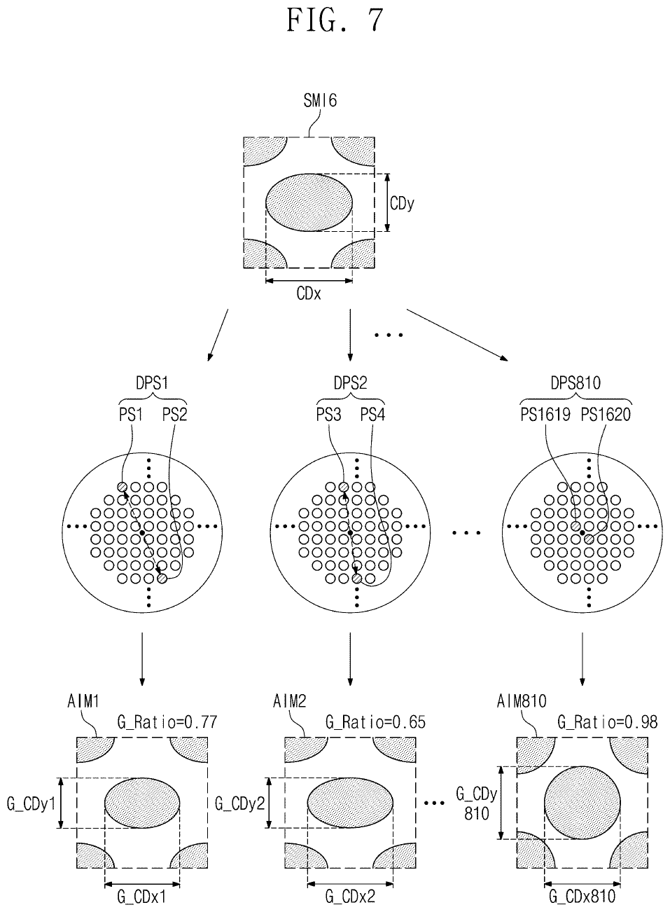

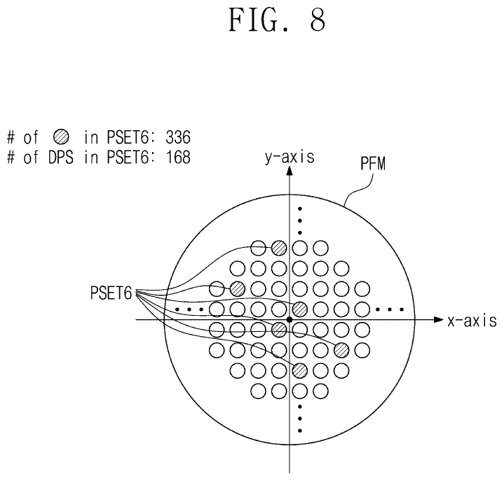

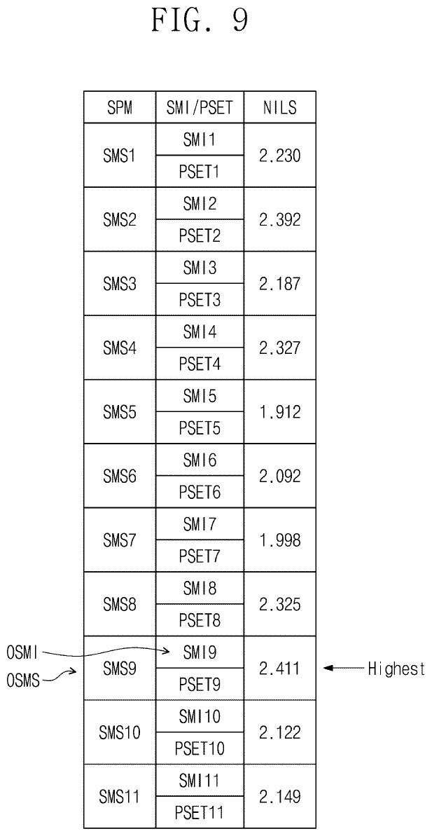

FIG. 2 is a flowchart illustrating an operating manner of a tool for a source mask optimization simulation in a device for optimizing the source mask of FIG. 1. FIG. 3 is a view illustrating a mask input image by way of example. FIG. 4 is a view to describe step S120 of FIG. 2. FIG. 5 is a flowchart to describe step S130 of FIG. 2. FIG. 6 is a view illustrating a PFM illumination system by way of example. FIG. 7 is a view to describe step S131 of FIG. 6. FIG. 8 is a view to describe step S132 of FIG. 6. FIG. 9 is a view to describe step S140 of FIG. 2. Hereinafter, the operating manner of the source mask optimization simulation will be described according to the present disclosure, with reference to the source mask optimization device 100 of FIG. 1.

Referring to FIG. 2, in step S110, the mask image and the user input UI may be input to the tool for the source mask optimization simulation of the source mask optimization device 100. The user input UI may include the target critical dimension T_CD, which is a target value for the critical dimension, the target aspect ratio T_Ratio, which is a target value for the aspect ratio of a unit shape, and the target constraints T_CST according to other process windows.

Referring to FIG. 3, a plurality of unit windows UW which are repeatedly arranged in the input mask image MI may be designated. The source mask optimization simulation may be performed with respect to the input mask image MI based on a unit shape included in the unit window UW. Although the unit shape is assumed to have an elliptical shape as in FIG. 3, the unit shape is not limited thereto and may be provided in a circular or prismatic shape.

According to an embodiment, a maximum value of a length of the unit shape in a first direction may be designated as a critical dimension ‘x’ CDx, and a maximum value of a length of the unit shape in a second direction may be designated as a critical dimension ‘y’ CDy. For example, the critical dimension ‘x’ CDx may refer to the length of the major axis of the unit shape, and the critical dimension ‘y’ CDy may refer to the length of the minor axis of the unit shape.

Referring to FIGS. 2 and 4, in step S120, the SMI generating unit 110 may generate the plurality of split mask images based on the mask image. For example, the plurality of split mask images may include the first to eleventh split mask images SMI1 to SMI11. In the first to eleventh split mask images SMI1 to SMI11, first to eleventh unit windows UW1 to UW11 may be repeatedly arrayed.

According to an embodiment, the SMI generating unit 110 may set a reference value of the length of the major axis of the unit shape to a target critical dimension ‘x’ T_CDx based on the target critical dimension T_CD, and may set the reference value of the length of the minor axis to the target critical dimension ‘y’ T_CDy. However, according to another embodiment, the SMI generating unit 110 may set the reference value of each of the length of the major axis and the length of the minor axis of the unit shape to a value preset in the device.

For example, the SMI generating unit 110 may set the length of the major axis of the unit shape of the sixth split mask image SMI6 as the target critical dimension ‘x’ T_CDx, and set the length of the minor axis as the target critical dimension ‘y’ T_CDy.

According to an embodiment, the lengths of the major axes of the first to eleventh split mask images SMI1 to SMI11 may increase by the constant interval of a first major axis scale 11. For example, from the sixth split mask image SMI6 in which the length of the major axis of the unit shape has the target critical dimension ‘x’ T_CDx, the length of the major axes of the fifth to first split mask images SMI5 to SMI1 may decrease by the interval of the first major axis scale 11, and the length of the major axis of the unit shape from the seventh to eleventh split mask images SMI7 to SMI11 may increase by the interval of the first major axis scale 11.

For example, the length of the major axis of the unit shape of the first split mask image SMI1 may be a value decreased by five times the first major axis scale 11 from the target critical dimension ‘x’ T_CDx. The length of the major axis of the unit shape of the second split mask image SMI2 is a value decreased by four times the first major axis scale 11 from the target critical dimension ‘x’ T_CDx. The length of the major axis of the unit shape of the third split mask image is a value decreased by three times the first major axis scale 11 from the target critical dimension ‘x’ T_CDx. The length of the major axis of the unit shape of the fourth split mask image is a value decreased by two times first major axis scale 11 from the target critical dimension ‘x’ T_CDx. The length of the major axis of the unit shape of the fifth split mask image is a value decreased by the first major axis scale 11 from the target critical dimension ‘x’ T_CDx.

For example, the length of the major axis of the unit shape of the seventh split mask image is a value increased by the first major axis scale 11 from the target critical dimension ‘x’ T_CDx. The length of the major axis of the unit shape of the eighth split mask image is a value increased by two times the first major axis scale 11 from the target critical dimension ‘x’ T_CDx. The length of the major axis of the unit shape of the ninth split mask image is a value increased by three times the first major axis scale 11 from the target critical dimension ‘x’ T_CDx. The length of the major axis of the unit shape of the tenth split mask image is a value increased by four times the first major axis scale 11 from the target critical dimension ‘x’ T_CDx. The length of the major axis of the unit shape of the eleventh split mask image is a value increased by five times the first major axis scale 11 from the target critical dimension ‘x’ T_CDx.

According to an embodiment, the lengths of the minor axes of the first to eleventh split mask images SMI1 to SMI11 may increase by a constant interval of the first minor axis scale s1. For example, from the sixth split mask image SMI6 in which the length of the minor axis of the unit shape has the target critical dimension ‘y’ T_CDy, the lengths of the minor axes of the unit shapes of the fifth to first split mask images SMI5 to SMI1 may be decreased by the interval of the first minor axis scale s1, and the length of the minor axis of the unit shape of the seventh to eleventh split mask images SMI7 to SMI11 may be increased by the interval of the first minor axis scale s1.

For example, the length of the minor axis of the unit shape of the first split mask image SMI1 may be a value increased by five times the first minor axis scale s1 from the target critical dimension ‘y’ T_CDy. The length of the minor axis of the unit shape of the second split mask image SMI2 may be a value increased by four times the first minor axis scale s1 from the target critical dimension ‘y’ T_CDy. The length of the minor axis of the unit shape of the third split mask image may be a value increased by three times the first minor axis scale s1 from the target critical dimension ‘y’ T_CDy. The length of the minor axis of the unit shape of the fourth split mask image may be a value increased by two times the first minor axis scale s1 from the target critical dimension ‘y’ T_CDy. The length of the minor axis of the unit shape of the fifth split mask image may be a value increased by the first minor axis scale s1 from the target critical dimension ‘y’ T_CDy.

For example, the length of the minor axis of the unit shape of the seventh split mask image may be a value decreased by the first minor axis scale s1 from the target critical dimension ‘y’ T_CDy. The length of the minor axis of the unit shape of the eighth split mask image may be a value decreased by two times the first minor axis scale s1 from the target critical dimension ‘y’ T_CDy. The length of the minor axis of the unit shape of the ninth split mask image may be a value decreased by three times the first minor axis scale s1 from the target critical dimension ‘y’ T_CDy. The length of the minor axis of the unit shape of the tenth split mask image may be a value decreased by four times the first minor axis scale s1 from the target critical dimension ‘y’ T_CDy. The length of the minor axis of the unit shape of the eleventh split mask image may be a value decreased by five times the first minor axis scale s1 from the target critical dimension y ‘T_CDy’.

The size of the first major axis scale 11 may be equal to or different from the size of the first minor axis scale s1.

Although the above-described embodiment has been described regarding the first to eleventh split mask images SMI1 to SMI11 split as 11 split mask images having the scale unit range between +5 to −5 times the scale about the target critical dimensions T_CDx and T_CDy, the number of split mask images is not limited thereto, and may be smaller or larger.

Referring back to FIG. 2, in step S130, the DPS simulation unit 120 may output a plurality of source mask sets by performing a dual point source simulation on each of the plurality of split mask images.

The dual point source simulation may be performed in parallel with respect to the plurality of split mask images. In other words, the dual point source simulation for the first split mask image SMI1, the dual point source simulation for the second split mask image SMI2, and the dual point source simulation for the eleventh split mask image SMI11 may be simultaneously performed.

Hereinafter, a dual point source simulation performed on the sixth split mask image SMI6 to output the sixth source mask set will be representatively described with reference to FIGS. 5 to 8.

Referring to FIG. 5, in step S131, the DPS simulation unit 120 may generate a plurality of aerial images by turning on each of the plurality of dual point source sets for the sixth split mask image SMI6.

Each dual point source set may include two point sources having a telecentric symmetry to each other about an origin point at which an X-axis and a Y-axis of the PFM illumination system cross each other. For example, each dual point source set may include two point sources that have point symmetry with respect to an origin point at which an X-axis and a Y-axis of the PFM illumination system cross each other.

Referring to FIGS. 6 and 7, point sources PS including mutually different dual point source sets DPS may be different from each other. For example, when 1620 point sources PS are provided to the PFM, the number of the dual point source sets DPS may be one half of 1620, or ‘810’. For example, each dual point source set may include two point sources PS that are not included in any other dual point source set.

For example, a first dual point source set DPS1 may include a first point source PS1 and a second point source PS2 which are telecentric symmetrical to each other on the PFM. For example, a second dual point source set DPS2 may include a third point source PS3 and a fourth point source PS4 which are telecentric symmetrical to each other on the PFM. For example, the 810-th dual point source set DPS810 may include a 1619-th point source PS1619 and a 1620-th point source PS1620 which are telecentric symmetrical to each other on the PFM.

The DPS simulation unit 120 may acquire one aerial image by turning on one dual point source set with respect to one split mask image. When one dual point source set is turned on, two point sources constituting the dual point source set may be turned on together.

For example, the DPS simulation unit 120 may acquire a first aerial image AIM1 by turning on the first dual point source set DPS1 for the sixth split mask image SMI6, acquire a second aerial image AIM2 by turning on the second dual point source set DPS2 for the sixth split mask image SMI6, and acquire an 810-th aerial image AIM810 by turning on the 810-th dual point source set DPS810 for the sixth split mask image SMI6 in the same manner.

Each aerial image is a result of performing optical proximity correction on the split mask image using each dual point source set, and may indicate an intensity distribution of light which is deformed by optical elements during the exposure process. For example, the optical proximity correction may be performed in consideration of an optical element to reflect, diffract, or refract light arriving from the point source to the photomask during the exposure process, such that the intensity and the shape of light arriving at the resist film on the wafer are deformed.

In step S132, the DPS simulation unit 120 may be configured to extract gauge information for each of the plurality of aerial images. For example, the gauge information may include a gauge aspect ratio G_Ratio.

The gauge aspect ratio G_Ratio may be calculated as a ratio between a gauge critical dimension ‘y’ G_CDy and a gauge critical dimension ‘x’ G_CDx based on the aerial image.

For example, the first gauge aspect ratio G_Ratio calculated based on the first aerial image AIM1 is 0.77, the second gauge aspect ratio G_Ratio calculated based on the second aerial image AIM2 is 0.65, and the 810-th gauge aspect ratio G_Ratio calculated based on the 810-th aerial image AIM810 is 0.98 (see FIG. 7).

In step S133, the DPS simulation unit 120 may select a specific number of aerial images from among a plurality of aerial images based on the target aspect ratio T_Ratio and gauge information. For example, the DPS simulation unit 120 may select a specific number of aerial images having the gauge aspect ratio G_Ratio closest to (e.g., closer than a threshold distance to) the target aspect ratio T_Ratio from among the plurality of aerial images. For example, the number of aerial images may be determined by a pre-established value based on user input, or it may be an arbitrary number based on the target constraints T_CST and gauge information.

For example, when the target aspect ratio T_Ratio value is 0.8 and 330 aerial images are selected, 330 aerial images having the gauge aspect ratio G_Ratio closest to the target aspect ratio T_Ratio among the first to 810-th aerial images AIM1 to AIM810 may be selected.

However, the DPS simulation unit 120 may calculate the specific number of aerial images using a loss function based on the target constraints T_CST, and the gauge information, without the limitation of the target aspect ratio T_Ratio.

In step S134, the DPS simulation unit 120 may select a point source set based on the selected aerial images. The DPS simulation unit may select the turned-on dual point source sets as a point source set to acquire the selected aerial images in step S131. For example, the selected point source set may be a set of point sources PS that is point symmetric about the origin point at which the X-axis and the Y-axis of the PFM illumination system cross each other.

The selected point source set may be output as one source mask set together with the split mask image. For example, sixth point source set PSET6 selected for the sixth split mask image SMI6 may be output in the form of a sixth point source set, together with the sixth split mask image SMI6 (see FIG. 8).

The DPS simulation unit 120 may perform the DPS simulation in steps S131 to S134 with respect to each of the plurality of split mask images. As a result of the simulation, the plurality of point source sets corresponding to the plurality of split mask images may be selected, such that the plurality of source mask sets may be output.

For example, the DPS simulation unit 120 may output the first to eleventh source mask sets SMS1 to SMS11 including the first to eleventh split mask images SMI1 to SMI11 and the first to eleventh point source sets PSET1 to PSET11 corresponding to the first to eleventh split mask images SMI1 to SMI11.

Referring back to FIG. 2, in step S140, the selecting unit 130 may select any one of the plurality of source mask sets as the optimal source mask set OSMS. The optimal source mask set OSMS may refer to the source mask set selected by the selecting unit 130, and the optimal split mask image OSMI may refer to the split mask image included in the optimal source mask set OSMS.

According to an embodiment, the selecting unit 130 may calculate the normalized image log slope (NILS) value for each of the plurality of source mask sets, and select the source mask set having the largest NILS value as the optimal source mask set OSMS. However, the present disclosure is not limited thereto, and the optimal source mask set OSMS may be selected based on the target constraints T_CST for another process window.

For example, referring to FIG. 9, when the NILS value of the ninth source mask set SMS9 among the NILS values of the first to eleventh source mask sets SMS1 to SMS11 is the largest, the selecting unit 130 may select the ninth source mask set SMS9 as the optimal source mask set OSMS. In this case, the ninth split mask image SMI9 included in the ninth source mask set SMS9 may be the optimal split mask image OSMI.

Referring back to FIG. 2, in step S150, the determining unit 140 may determine whether the optimal source mask set OSMS satisfies the target constraints T_CST.

Step S190 may be performed depending on the result of the determination that the optimal source mask set OSMS satisfies the target constraints T_CST. In step S190, the determining unit 140 may output an illumination system and a mask output set SMOS based on the optimal source mask set OSMS.

Step S160 may be performed depending on the result of the determination that the optimal source mask set OSMS fails to satisfy the target constraints T_CST. In step S160, the determining unit 140 may determine whether the SMI generating unit 110 performs the splitting in a minimum scale unit. The minimum scale unit may be a value preset in the source mask optimization device 100 or a value set through the user input UI.

Depending on the determination result that the SMI generating unit 110 performs the splitting in the minimum scale unit, step S190 may be performed to output the illumination system and the mask, based on the optimal source mask set OSMS.

Step S170 may be performed depending on the result of determining that the SMI generating unit 110 fails to perform the splitting in the minimum scale unit.

In step S170, the determining unit 140 may provide the optimal split mask image OSMI included in the optimal source mask set OSMS as the input of the SMI generating unit 110.

In step S180, the SMI generating unit 110 may re-generate a plurality of split mask images based on the optimal split mask image OSMI received from the determining unit 140. In this case, the SMI generating unit 110 may set the scale to be smaller and split the length of the major axis and the length of the minor axis of the unit shape.

For example, the first to eleventh split mask images SMI1 to SMI11 may be generated again through constantly-splitting at a second major axis scale 12, based on the length of the major axis of the unit shape of the optimal split mask image OSMI, and through constantly-splitting at a second minor axis scale s2, based on the length of the minor axis of the unit shape of the optimal split mask image OSMI.

According to an embodiment, the second major axis scale 12 may be smaller than the first major axis scale 11, and the second minor axis scale s2 may be smaller than the first minor axis scale s1.

In the same manner, steps S130 to S180 may be repeatedly performed based on the first to eleventh split mask images SMI1 to SMI11, until the SMI generating unit 110 performs the splitting in the minimum scale unit in step S180, or the optimal split mask image OSMI satisfies the target constraints T_CST in step S160.

According to an embodiment according to the present disclosure, the output point source set may include dual point source sets which are telecentric symmetrical to each other. Accordingly, the pattern shift phenomenon may be more effectively prohibited, when the lithography process is performed using the output point source according to the present disclosure.

According to an embodiment of the present disclosure, the source mask optimization simulation may be performed in parallel with the generating of the plurality of split images by splitting the input mask image MI. Accordingly, Turn Around Time (TAT) required for the source mask optimization simulation of the present disclosure may be smaller than the case where the source mask optimization simulation is sequentially performed while adjusting the size of the pattern of the mask image.

According to an embodiment of the present disclosure, when the dual point source simulation is performed, two point sources may be simultaneously turned on. In other words, according to the present disclosure, an output point source set may be acquired by performing only a simulation with respect to only half of point sources among a plurality of point sources on a PFM. Accordingly, Turn Around Time (TAT) required for the source mask optimization simulation of the present disclosure may be smaller than the case of performing the source mask optimization simulation on all point sources according to the present disclosure.

According to an embodiment of the present disclosure, it is possible to reduce the scale for splitting the mask image whenever the split operation is repeated. Accordingly, resolution and accuracy of the pattern of the output mask image may be improved.

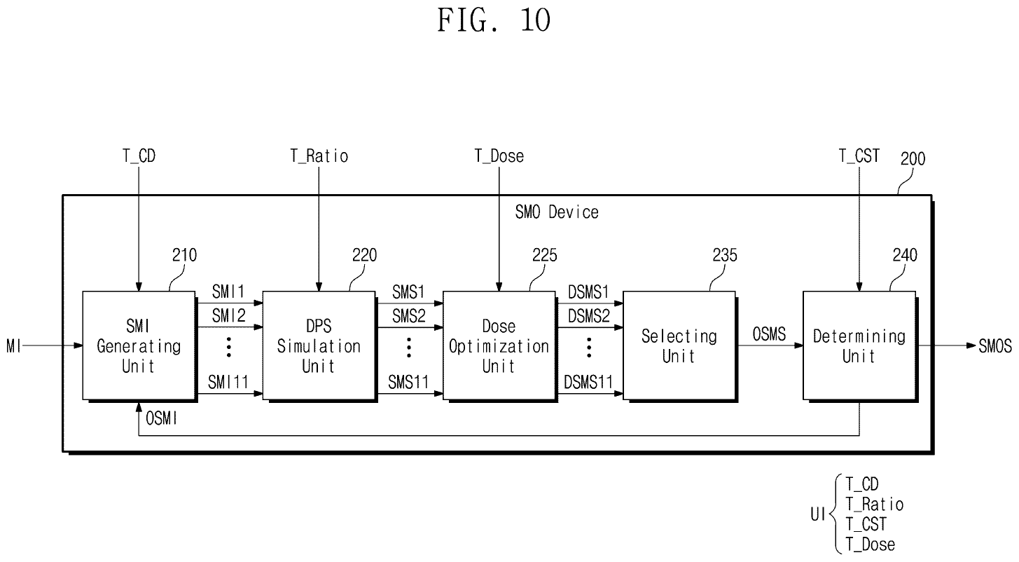

FIG. 10 is a block diagram illustrating a device for optimizing a source mask according to an embodiment of the present disclosure.

A source mask optimization device 200 may include a split mask image generating unit 210, a DPS simulation unit 220, a dose optimization unit 225, a selecting unit 235, and a determining unit 240. The split mask image generating unit 210, the DPS simulation unit 220, and the determining unit 240 may be configured to operate in the same manner as those illustrated in FIG. 1. The following description will be made while focusing on a difference from the source mask optimization device 100 in FIG. 1.

The source mask optimization device 200 may be configured to generate an illumination system and a mask output set SMOS by performing a source mask optimization simulation based on a mask image and the user input UI. Unlike in FIG. 1, the user input UI may further include a target dose value T_Dose, which is a target value for a degree of light exposure of the resist pattern.

The dose optimization unit 225 may be configured to perform dose optimization on each of the plurality of source mask sets based on the target dose value T_Dose. As a result of performing the dose optimization, the dose optimization unit 225 may be configured to generate a plurality of dose optimization source mask sets. For example, the dose optimization unit 225 may perform dose optimization by adjusting a size of the unit shape based on the targe dose value T_Dose as described below.

Each of the plurality of dose optimized source mask sets may include a dose-optimized split mask image and a point source set corresponding to the doze-optimized split mask image. For example, the plurality of dose optimized source mask sets may include first to eleventh dose-optimized split mask images DSMS1 to DSMS11 and first to eleventh point source sets PSET1 to PSET11 corresponding to the first to eleventh split mask images SMI1 to SMI11.

The selecting unit 235 may select the optimal source mask set OSMS from among the plurality of dose optimized source mask sets. As illustrated in FIGS. 1 to 9, the selecting unit 235 may be configured to select the optimal source mask set OSMS based on the NILS value.

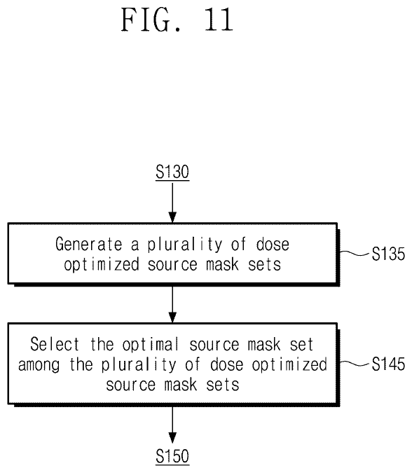

Hereinafter, operations of the dose optimization unit 225 and the selecting unit 235 will be described with reference to FIGS. 11 to 13.

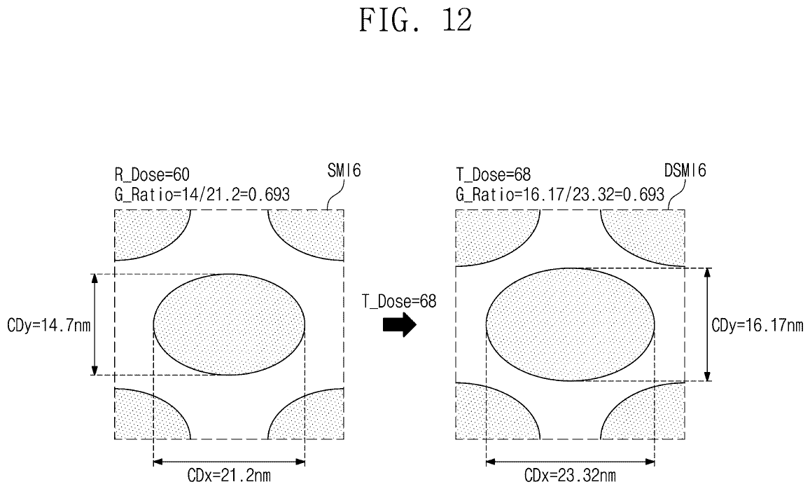

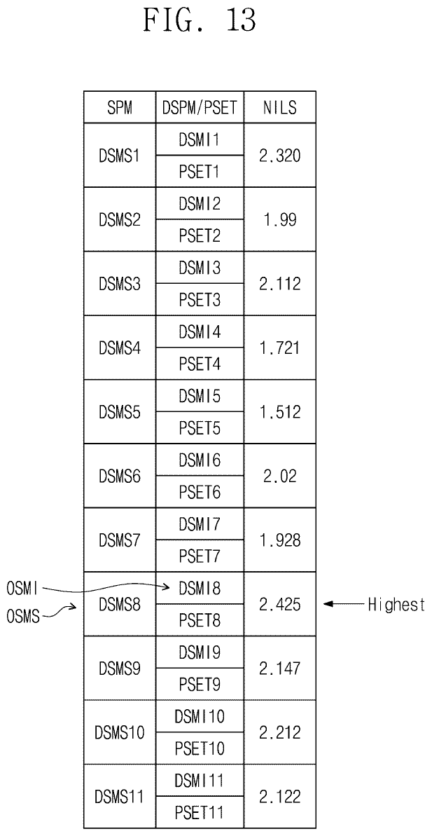

FIG. 11 is a flowchart illustrating operations of a dose optimization unit and a selecting unit of FIG. 10. FIG. 12 is a view to describe step S135 of FIG. 11. FIG. 13 is a view to describe step S145 of FIG. 11. According to an embodiment, after step S130 in FIG. 2 is finished, steps S135 and S145 are performed, and the following steps after step S150 in FIG. 2 may be identically performed.

Referring to FIGS. 11 and 12, in step S135, the dose optimization unit 225 may generate a plurality of dose optimized source mask sets by performing dose optimization on each of the plurality of source mask sets.

Each dose optimized source mask set may include a dose optimized split mask image and the point source set corresponding to the dose optimized split mask image. For example, the plurality of dose optimized source mask sets may include the first to eleventh dose optimized split mask images DSMS1 to DSMS11 and the first to eleventh point source sets PSET1 to PSET11. The first to eleventh point source sets PSET1 to PSET11 may be the same as those included in the plurality of source mask sets.

The dose value may refer to the degree of light exposure of the resist pattern when lithography is performed using the point source set of the source mask set. For example, when the degree of light exposure is smaller, a smaller dose value may be shown.

When performing the lithography process using the source mask set, the size of the resist pattern generated on the wafer may vary depending on the dose value. Accordingly, to acquire a resist pattern having a target unit pattern size by performing the lithography process, it is necessary to appropriately set the target dose value T_Dose. According to the present disclosure, the target dose value T_Dose may refer to an appropriately set dose value as described above.

In addition, it is necessary to adjust the unit pattern size of the photomask to have a target resist pattern based on the set target dose value T_Dose.

The dose optimization unit 225 may perform dose optimization by adjusting the size of the unit shape of each split mask image, based on the target dose value T_Dose.

The dose optimization unit 225 may maintain the array form of the unit shapes of each split mask image, but increase or decrease the length of the major axis and the length of the minor axis of the unit shape by a specific ratio to generate a dose-optimized split mask image.

According to an embodiment, when the reference dose value is set, the dose optimization unit 225 may adjust the length of the major axis and the length of the minor axis of the unit shape, based on the ratio of the reference dose value to the target dose value T_Dose. For example, while maintaining the aspect ratio in the unit shape to 0.693 which is the existing aspect ratio, the length of the major axis may be increased from 21.2 nm to 23.32, and the length of the minor axis may be increased to 16.17.

Referring to FIGS. 11 and 13, in step S145, the selecting unit 235 may select the optimal source mask set OSMS among the plurality of dose optimized source mask sets. As illustrated in FIGS. 1 to 9, the selecting unit 235 may be configured to select the optimal source mask set OSMS based on the normalized image log gradient (NILS) value.

For example, when the NILS value of the eighth dose optimized source mask set DSMS8 is the largest among NILS values of the first to eleventh dose optimized source mask sets DSMS1 to DSMS11, the selecting unit 235 may select the eighth dose optimized source mask set DSMS8 as the optimal source mask set OSMS. In this case, the eighth dose-optimized split mask image DSMI8 included in the eighth dose optimized source mask set DSMS8 may be the optimal split mask image OSMI.

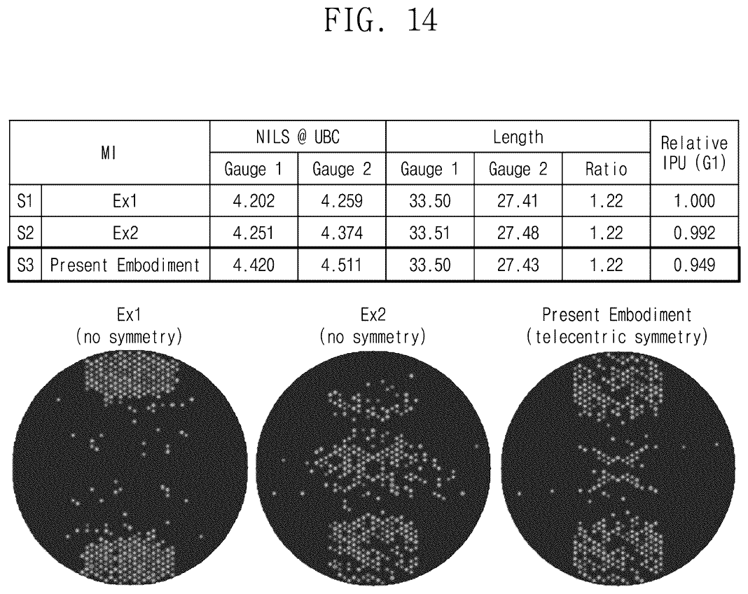

FIG. 14 is a view illustrating results of a source mask optimization simulation according to comparative examples and embodiments of the present disclosure.

Referring to FIG. 14, a plurality of point source sets constituting a point source set of an illumination system in each of the first and second comparative examples do not have symmetry, and a point source set of an illumination system according to an embodiment of the present disclosure includes a plurality of dual point source sets having telecentric symmetry.

According to an embodiment of the present disclosure, it may be confirmed that a higher normalized image value and a lower IPU value are shown, as compared to those of the first comparative example and the second comparative example.

FIG. 15 is a block diagram illustrating an implementation of a device for optimizing a source mask according to the present disclosure. Referring to FIG. 15, a source mask optimization device 300 may include at least one processor 310, a working memory 320, a storage 330, and an input/output device 340. In this case, the source mask optimization device 300 may be provided as a dedicated device for executing a tool for a source mask optimization simulation according to an embodiment of the present disclosure. In addition, the source mask optimization device 300 may be configured to drive various simulation programs.

The processor 310 may execute software (e.g., an application program, an operating system, and device drivers) to be executed in the source mask optimization device 300. The processor 310 may execute an operating system (OS) loaded in the working memory 320. The processor 310 may execute various application programs to be driven based on the operating system (OS). The processor 310 may execute the tool for the source mask optimization simulation loaded in the working memory 320 from the storage 330.

The operating system (OS) or application programs may be loaded into the working memory 320. When the source mask optimization device 300 is booted, an OS image stored in the storage 330 may be loaded into the working memory 320 in the sequence of the booting. All input/output operations of the source mask optimization device 300 may be supported by the operating system (OS). Similarly, application programs may be selected by a user or loaded into the working memory 320 to provide a basic service. In particular, the source mask optimization simulation tool for source mask optimization according to the present disclosure may also be loaded from the storage 330 into the working memory 320.

When executed by the processor, the source mask optimization simulation tool may output an illumination system and a mask output set based on an input mask image and a user input, as described with reference to FIGS. 2 to 13.

The working memory 320 may include a volatile memory such as a static random access memory (SRAM) or a dynamic random access memory (DRAM). However, the present disclosure is not limited thereto.

The storage 330 may be provided as a storage medium of the source mask optimization device 300. The storage 330 may store application programs, operating system images, and various pieces of data. In particular, the source mask optimization simulation tool according to an embodiment of the present disclosure may be included among application programs stored in the storage 330.

The source mask optimization simulation tool of the present disclosure may be a computer program product including a computer-readable program code, or a computer program product including a non-transitory computer-usable medium including a computer-readable program code. Additionally or alternatively, the source mask optimization simulation tool according to the present disclosure may be a downloadable product from the Internet.

For example, the storage 330 may be provided in the form of a solid state drive (SSD), an embedded multi-media card (eMMC), or a hard disk drive (HDD). The storage 330 may include a NAND flash memory. However, the present disclosure is not limited thereto, and the storage 330 may include a nonvolatile memory such as PRAM, MRAM, ReRAM, or FRAM, or a NOR flash memory.

The input/output device 340 may include various devices, such as a keyboard, a mouse, or a monitor, to receive information from a designer or provide information to the designer. For example, values of various target information input by the user input into the source mask optimization simulation tool may be set through the input/output device 340, and a processing procedure and a processing result may be displayed.

In particular, an output point source set and an output mask image of an illumination system and a mask output set generated according to embodiments of the present disclosure may be output through the input/output device 340. The illumination system of a field facet mirror and a pupil facet mirror may be set in a lithography device, based on the output point source set, and a mask may be generated by a device for fabricating a mask, based on the output mask image.

The following description will be made regarding a method for fabricating a resist pattern on a wafer in a device for fabricating a mask and a lithography device.

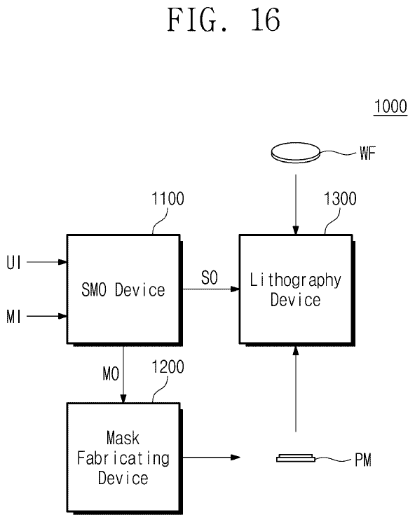

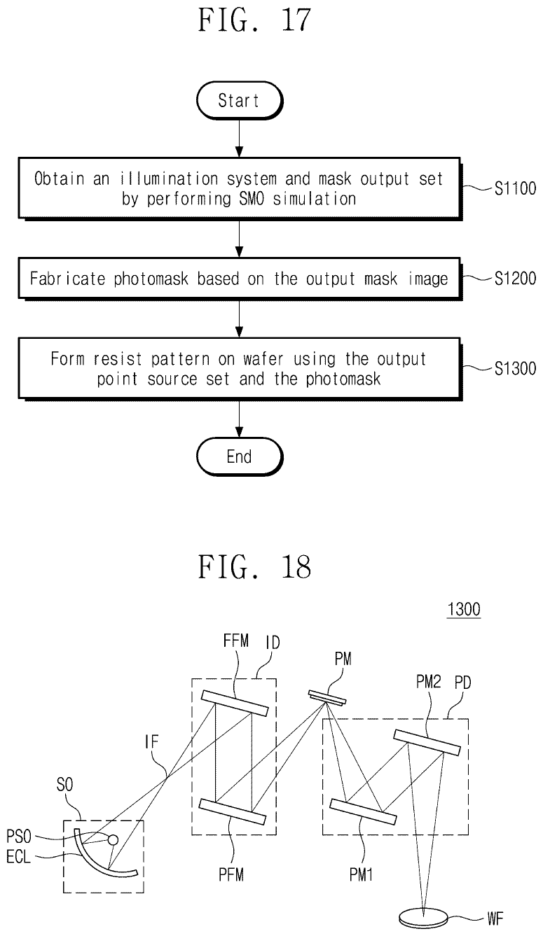

FIG. 16 is a view illustrating a lithography system according to an embodiment of the present disclosure. FIG. 17 is a flowchart to describe an operation of a lithography system of FIG. 16.

Referring to FIGS. 16 and 17, a lithography system 1000 may include a source mask optimization device 1100, a mask fabricating device 1200, and a lithography device 1300.

In step S1100, the lithography system 1000 may output an illumination system and a mask output set including an output point source set SO and an output mask image MO corresponding to the output point source set SO by performing a source mask optimization simulation tool according to the present disclosure in the source mask optimization device 1100. The source mask optimization device 1100 may be any one of embodiments described with reference to FIGS. 1 to 15.

In step S1200, the mask fabricating device 1200 may fabricate a photomask PM based on the output mask image MO of the illumination system and the mask output set. The photomask PM may be a reticle including pellicles having a pattern shape of the output mask image MO.

The mask fabricating device 1200 may include deposition equipment and patterning equipment to form pellicles on appropriate reticles. The mask fabricating device 1200 may form a photomask by attaching a pellicle to a reticle together with a pellicle frame.

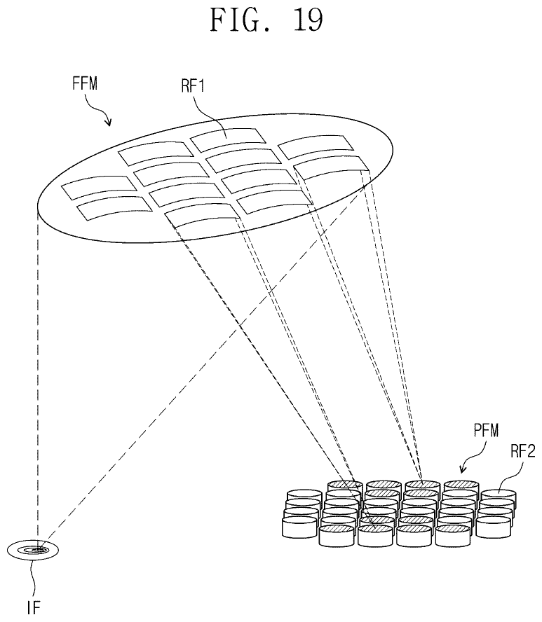

In step S1300, the lithography device 1300 may be configured to form a target resist pattern on a wafer WF by using the photomask PM. The lithography device 1300 may be an EUV lithography device including a field facet mirror and a pupil facet mirror. A field facet mirror (FFM) and the pupil facet mirror (PFM) of the lithography device 1300 may be set to serve as point light sources according to the output point source set SO. Hereinafter, the lithography device 1300 will be described in detail with reference to FIGS. 18 and 19.

FIG. 18 is a view illustrating the lithography device of FIG. 15. FIG. 19 is a view illustrating a field facet mirror and a pupil facet mirror of FIG. 18.

Referring to FIG. 18, the lithography device 1300 includes a source collector module SO, a lighting device ID, and a projection device PD.

The source collector module SO may include a plasma source PSO and a radiation collector ECL.

The plasma source PSO is configured to generate light. For example, the light may be an electromagnetic spectrum having an EUV band emitted by significantly high-temperature discharge plasma. For example, the light may be generated through discharge plasma of a gas or vapor, such as Xe gas, Li vapor, or Sn vapor.

The radiation collector ECL may be configured to focus light to an intermediate focus IF. The intermediate focus IF is a point where light is focused and may be referred to as a virtual EUV point source. In other words, it may be considered that light is emitted from the intermediate focus IF.

A lighting device may be configured to provide light emitted from the intermediate focus IF to the photomask PM. The lighting device may include the field facet mirror FFM and the pupil facet mirror PFM.

The field facet mirror FFM may reflect light toward the pupil facet mirror PFM, and the pupil facet mirror PFM may be configured to focus light on the photomask PM.

Referring to FIG. 19, the field facet mirror FFM may include a plurality of first reflective elements RF1, and the pupil facet mirror PFM may include a plurality of second reflective elements RF2. Each of the plurality of first reflective elements RF1 of the field facet mirror FFM may be configured to reflect light to any one of the plurality of second reflective elements RF2 of the pupil facet mirror PFM.

In the present specification, each point source may refer to the second reflective element RF2 at a point where light is reflected on the pupil facet mirror PFM.

According to an embodiment, the second reflective elements RF2 of the pupil facet mirror PFM illumination system corresponding to the output point source set SO output from the source mask optimization device 1100 may be turned on.

In the present specification, a point source may be turned on when the first reflective element RF1 of the field facet mirror FFM is moved to be disposed such that light is reflected from the corresponding second reflective element RF2 at the point source position on the pupil facet mirror PFM.

Referring back to FIG. 18, patterned light may be generated when light is reflected by the photomask PM.

The projection device PD may include a first projection mirror PM1 and a second projection mirror PM2. The patterned light may be sequentially reflected by the first projection mirror PM1 and the second projection mirror PM2 to be irradiated onto the wafer WF.

The lighting device ID and the projection device PD may include more mirrors or lenses.

According to an embodiment, the source mask optimization device may be provided to simultaneously output the optimized illumination system and the optimized mask which satisfy the constraints.

According to an embodiment, the source mask optimization device may be provided to perform the dose optimization.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A non-transitory computer-readable medium comprising:
a program code configured, when executed by a processor, to perform the following:
generating a plurality of split mask images based on an input mask image;
generating a plurality of source mask sets corresponding to the plurality of split mask images, by performing a dual point source simulation for each of the plurality of split mask images, based on a plurality of dual point source sets;
generating a plurality of dose optimized source mask sets by performing dose optimization with respect to each of the plurality of source mask sets, based on a target value for a degree of light exposure of a resist pattern to be formed based on an output mask image, each of the plurality of dose optimized source mask sets including a dose optimized split mask image and a dose optimized point source set;
selecting an optimal source mask set from among the plurality of dose optimized source mask sets, the optimal source mask set including an optimal split mask image and an optimal point source set;
determining whether the optimal source mask set satisfies input target constraints; and
outputting, based on the determination result, the optimal point source set and the optimal split mask image, and
wherein each of the plurality of dual point source sets includes two point sources having telecentric symmetry with respect to each other.

2. The non-transitory computer-readable medium of claim 1, wherein the input mask image includes a plurality of first unit shapes arranged in an array, and
wherein each of the plurality of split mask images includes a plurality of second unit shapes having the same array form as the plurality of first unit shapes, each of the plurality of second unit shapes being different from the plurality of first unit shapes in shape or size.

3. The non-transitory computer-readable medium of claim 2, wherein the generating of the plurality of source mask sets includes generating the plurality of split mask images different from each other in a length of a major axis of the second unit shape and a length of a minor axis of the second unit shape.

4. The non-transitory computer-readable medium of claim 1, wherein the dual point source simulation for each of the plurality of split mask images includes:
generating a plurality of aerial images by turning on each of the plurality of dual point source sets for each split mask image of the plurality of split mask images, each of the plurality of aerial images corresponding to a respective split mask image and to a respective dual point source set;
extracting gauge information for each of the plurality of aerial images;
selecting a specific number of aerial images from among the plurality of aerial images based on the gauge information;
selecting a point source set including dual point source sets that correspond to the selected aerial images; and
outputting a source mask set, the source mask set including the selected point source set and the split mask image.

5. The non-transitory computer-readable medium of claim 4, wherein the gauge information includes a gauge aspect ratio, and
wherein the selecting of the specific number of aerial images from among the plurality of aerial images includes selecting the specific number of aerial images from among the plurality of aerial images in sequence in which the gauge aspect ratio is closer than a threshold distance to a target aspect ratio.

6. The non-transitory computer-readable medium of claim 1, wherein the selecting of the optimal source mask set from among the plurality of dose optimized source mask sets includes selecting the optimal source mask set, based on a normalized image log-slope (NILS) of the plurality of source mask sets.

7. The non-transitory computer-readable medium of claim 1, wherein the input target constraints include one of: dose constraints associated with a degree of light exposure in a lithography process, critical dimension constraints associated with a critical dimension of a pattern, or NILS constraints associated with an NILS value.

8. The non-transitory computer-readable medium of claim 1, wherein the generating of the plurality of dose optimized source mask sets by performing the dose optimization includes generating the dose optimized split mask image by adjusting a size of a unit shape of the split mask image of each of the plurality of source mask sets.

9. The non-transitory computer-readable medium of claim 1, wherein the method further includes:
based on the determination result that the optimal source mask set fails to satisfy the input target constraints, re-generating a plurality of split mask images based on an optimal split mask image included in the optimal source mask set.

10. The non-transitory computer-readable medium of claim 9, wherein the re-generating of the plurality of split mask images includes:
generating the plurality of split mask images by setting a scale to be smaller than a scale used previously in the generating of the split mask images.

11. A method comprising: using a source mask optimization simulation tool:
generating a plurality of split mask images based on an input mask image;
generating a plurality of source mask sets corresponding to the plurality of split mask images, by performing a dual point source simulation for each of the plurality of split mask images, based on a plurality of dual point source sets;
generating a plurality of dose optimized source mask sets by performing dose optimization with respect to each of the plurality of source mask sets, based on a target value for a degree of light exposure of a resist pattern to be formed based on an output mask image, each of the plurality of dose optimized source mask sets including a dose optimized split mask image and a dose optimized point source set;
selecting an optimal source mask set from among the plurality of dose optimized source mask sets, the optimal source mask set including an optimal split mask image and an optimal point source set;
determining whether the optimal source mask set satisfies input target constraints;
outputting the optimal source mask set based on the determination result;
fabricating a photomask, based on an optimal split mask image of the optimal source mask set; and
forming the resist pattern on a wafer by performing a lithography process based on an optimal point source set of the optimal source mask set, and the photomask,
wherein each of the plurality of dual point source sets includes two point sources having a telecentric symmetry with respect to each other.

12. The method of claim 11, wherein the input mask image includes:
a plurality of first unit shapes arranged in an array, and
wherein each of the plurality of split mask images include a plurality of second unit shapes having the same array form as the plurality of first unit shapes, each of the plurality of second unit shapes being different from the plurality of first unit shapes in shape or size.

13. The method of claim 11, wherein the dual point source simulation for each of the plurality of split mask images includes:
generating a plurality of aerial images by turning on each of the plurality of dual point source sets for each split mask image of the plurality of split mask images, each of the plurality of aerial images corresponding to a respective split mask image and to a respective dual point source set;
extracting gauge information for each of the plurality of aerial images;
selecting a specific number of aerial images from among the plurality of aerial images based on the gauge information;
selecting a point source set including dual point source sets that correspond to the selected aerial images; and
outputting a source mask set, the source mask set including the selected point source set and the split mask image.

14. The method of claim 13, wherein the gauge information includes a gauge aspect ratio, and
wherein the selecting of the specific number of aerial images from among the plurality of aerial images includes selecting the specific number of aerial images from among the plurality of aerial images, which have a gauge aspect ratio closer to a target aspect ratio than a threshold distance.

15. The method of claim 11, wherein the performing of the dose optimization includes generating the dose optimized split mask image by adjusting a size of a unit shape of a split mask image of each of the plurality of source mask sets to perform the dose optimization.

16. The method of claim 11, further comprising:
based on the determination result that the optimal source mask set fails to satisfy the input target constraints, re-generating a plurality of split mask images based on an optimal split mask image included in the optimal source mask set.

17. The method of claim 11, further comprising:
setting a field facet mirror and a pupil facet mirror of a lithography device to serve as point light sources based on the optimal point source set, in the forming of the resist pattern on the wafer by performing a lithography process.

18. A non-transitory computer program stored in a storage medium and configured to perform, by using a computer, a method including:
generating a plurality of split mask images based on an input mask image;
generating a plurality of source mask sets corresponding to the plurality of split mask images, by performing a dual point source simulation for each of the plurality of split mask images, based on a plurality of dual point source sets;
selecting an optimal source mask set from among the plurality of source mask sets, the optimal source mask set including an optimal split mask image and an optimal point source set;
determining whether the optimal source mask set satisfies input target constraints; and
outputting the optimal source mask set based on the determination result,
wherein each of the plurality of dual point source sets includes two point sources having a telecentric symmetry with respect to each other.

19. The non-transitory computer program of claim 18, wherein the generated plurality of split mask images are different from each other in a length of a major axis and a length of a minor axis of a unit shape of the plurality of split mask images.

20. The non-transitory computer program of claim 18, wherein the dual point source simulation for each of the plurality of split mask images includes:
generating a plurality of aerial images by turning on each of the plurality of dual point source sets for each split mask image of the plurality of split mask images, each of the plurality of aerial images corresponding to a respective split mask image and to a respective dual point source set;
extracting gauge information for each of the plurality of aerial images;
selecting a specific number of aerial images from among the plurality of aerial images based on the gauge information;
selecting a point source set including dual point source sets that correspond to the selected aerial images; and
outputting a source mask set, the source mask set including the selected point source set and the split mask image.
